(19) United States
(12) Patent Application Publication
(10) Pub. No.: US 2025/0168826 A1
(43) Pub. Date: May 22, 2025

(54) ENHANCEMENT FOR APERIODIC SOUNDING REFERENCE SIGNAL SCHEDULING

(71) Applicant: QUALCOMM Incorporated, San Diego, CA (US)

(72) Inventors: Fang YUAN, Beijing (CN); Luanxia YANG, Beijing (CN); Shuanshuan WU, San Diego, CA (US); Tao LUO, San Diego, CA (US); Xiaoxia ZHANG, San Diego, CA (US)

(21) Appl. No.: 18/836,549

(22) PCT Filed: Apr. 6, 2022
(86) PCT No.: PCT/CN2022/085254

§ 371 Date: Aug. 7, 2024

(51) Int. Cl. H04W 72/044; H04L 5/00; H04W 8/24; H04W 72/23

(52) U.S. Cl. CPC H04W 72/044; H04L 5/0005; H04L 5/005; H04W 8/24; H04W 72/23

(57) ABSTRACT

Methods, systems, and devices for enhanced aperiodic sounding reference signal (A-SRS) scheduling are described. In some examples, a user equipment (UE) may transmit, to a base station, a capability message that indicates a capability of the UE to support dynamic scheduling of resources for an SRS. In some examples, the UE may receive, from the base station in response to the capability message, a downlink control message indicating a time domain allocation for the SRS and a frequency domain allocation for the SRS. In some examples, the UE may transmit the SRS using a set of resources in response to the downlink control message, the set of resources selected based at least in part on the time domain allocation for the SRS and the frequency domain allocation for the SRS.

### CROSS REFERENCE

The present application is a 371 national phase filing of International PCT Application No. PCT/CN2022/085254 by YUAN et al., entitled “ENHANCEMENT FOR APERIODIC SOUNDING REFERENCE SIGNAL SCHEDULING,” filed Apr. 6, 2022, which is assigned to the assignee hereof, and which is expressly incorporated by reference in its entirety herein.

### FIELD OF TECHNOLOGY

The following relates to wireless communications, including enhancement for aperiodic sounding reference signal (A-SRS) scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support enhancement for aperiodic sounding reference signal (A-SRS) scheduling. Generally, the described techniques provide for dynamic scheduling of resource allocation for A-SRS transmission. For example, to support dynamic indication of frequency resources for A-SRS transmission, a base station may indicate an A-SRS frequency resource allocation and an A-SRS time resource allocation for a user equipment (UE) to use to transmit A-SRS. Upon receiving the indication, the UE may identify the A-SRS frequency resource allocation, the A-SRS time resource allocation, or both, and may transmit the A-SRS in accordance with the A-SRS frequency resource allocation and the A-SRS time resource allocation.

A method for wireless communications at a UE is described. The method may include receiving, from a base station, a downlink control message indicating a time domain allocation for an SRS and a frequency domain allocation for the SRS, and transmitting the SRS using a set of resources in response to the downlink control message, the set of resources selected based on the time domain allocation for the SRS and the frequency domain allocation for the SRS.

An apparatus for wireless communications at a UE is described. The apparatus may include a processor, memory coupled with the processor, and instructions stored in the memory. The instructions may be executable by the processor to cause the apparatus to receive, from a base station, a downlink control message indicating a time domain allocation for an SRS and a frequency domain allocation for the SRS, and transmit the SRS using a set of resources in response to the downlink control message, the set of resources selected based on the time domain allocation for the SRS and the frequency domain allocation for the SRS.

Another apparatus for wireless communications at a UE is described. The apparatus may include means for receiving, from a base station, a downlink control message indicating a time domain allocation for an SRS and a frequency domain allocation for the SRS, and means for transmitting the SRS using a set of resources in response to the downlink control message, the set of resources selected based on the time domain allocation for the SRS and the frequency domain allocation for the SRS.

A non-transitory computer-readable medium storing code for wireless communications at a UE is described. The code may include instructions executable by a processor to receive, from a base station, a downlink control message indicating a time domain allocation for an SRS and a frequency domain allocation for the SRS, and transmit the SRS using a set of resources in response to the downlink control message, the set of resources selected based on the time domain allocation for the SRS and the frequency domain allocation for the SRS.

Some examples of the method, apparatuses, and non-transitory computer-readable medium described herein may further include operations, features, means, or instructions for transmitting, to the base station, a capability message that indicates a capability of the UE to support dynamic scheduling of resources for the sounding reference signal.

In some examples of the method, apparatuses, and non-transitory computer-readable medium described herein, transmitting the SRS may include operations, features, means, or instructions for transmitting the SRS using a set of frequency resources of the set of resources based on the frequency domain allocation, where the set of frequency resources may be a truncated set of a total set of frequency resources indicated by the frequency domain allocation.

In some examples of the method, apparatuses, and non-transitory computer-readable medium described herein, transmitting the SRS may include operations, features, means, or instructions for transmitting the SRS using a set of frequency resources of the set of resources based on the frequency domain allocation, where the set of frequency resources includes multiple subsets of consecutive resources in a frequency domain.

Some examples of the method, apparatuses, and non-transitory computer-readable medium described herein may further include operations, features, means, or instructions for receiving, from the base station, an indication of a reference signal resource configuration for the UE and transmitting the SRS using a set of frequency resources of the set of resources based on the frequency domain allocation, where the set of frequency resources includes an integer multiple of resource blocks (RBs) indicated by the reference signal resource configuration.

In some examples of the method, apparatuses, and non-transitory computer-readable medium described herein, receiving the downlink control message may include operations, features, means, or instructions for receiving one or more bits indicating a bandwidth for the SRS, where the SRS may be transmitted using the bandwidth.

In some examples of the method, apparatuses, and non-transitory computer-readable medium described herein, receiving the downlink control message may include operations, features, means, or instructions for receiving one or more bits indicating one or more resource configuration parameters for the SRS, where the SRS may be transmitted in accordance with the one or more resource configuration parameters.

In some examples of the method, apparatuses, and non-transitory computer-readable medium described herein, the one or more resource configuration parameters includes a bandwidth configuration index, a number of RBs, a number of SRSs for transmission, a frequency hopping parameter, or any combination thereof.

In some examples of the method, apparatuses, and non-transitory computer-readable medium described herein, transmitting the SRS may include operations, features, means, or instructions for transmitting the SRS using a set of time resources of the set of resources based on the time domain allocation, where the time domain allocation indicates a starting symbol value for the SRS, a number of symbols for the SRS, a time offset for the SRS, a repetition factor, or any combination thereof.

Some examples of the method, apparatuses, and non-transitory computer-readable medium described herein may further include operations, features, means, or instructions for receiving a control message indicating a configuration for the UE for receiving the downlink control message.

In some examples of the method, apparatuses, and non-transitory computer-readable medium described herein, the configuration indicates a bitwidth for one or more fields of the downlink control message and the one or more fields indicate the set of resources for the SRS.

In some examples of the method, apparatuses, and non-transitory computer-readable medium described herein, transmitting the capability message may include operations, features, means, or instructions for transmitting an indication of a supported bandwidth for the SRS, a time offset for the SRS, or any combination thereof.

In some examples of the method, apparatuses, and non-transitory computer-readable medium described herein, receiving the downlink control message may include operations, features, means, or instructions for receiving, in the downlink control message, one or more bits indicating an absence of an uplink shared channel transmission via a physical uplink shared channel (PUSCH).

In some examples of the method, apparatuses, and non-transitory computer-readable medium described herein, receiving the downlink control message may include operations, features, means, or instructions for receiving, in the downlink control message, a frequency domain resource assignment (FDRA) field that indicates the frequency domain allocation.

In some examples of the method, apparatuses, and non-transitory computer-readable medium described herein, receiving the downlink control message may include operations, features, means, or instructions for receiving, in the downlink control message, a time domain resource assignment (TDRA) field that indicates the time domain allocation.

A method for wireless communications at a base station is described. The method may include transmitting, to a UE, a downlink control message indicating a time domain allocation for an SRS and a frequency domain allocation for the SRS, and monitoring a set of resources for the SRS, the set of resources based on the time domain allocation for the SRS and the frequency domain allocation for the SRS.

An apparatus for wireless communications at a base station is described. The apparatus may include a processor, memory coupled with the processor, and instructions stored in the memory. The instructions may be executable by the processor to cause the apparatus to transmit, to a UE, a downlink control message indicating a time domain allocation for an SRS and a frequency domain allocation for the SRS, and monitor a set of resources for the SRS, the set of resources based on the time domain allocation for the SRS and the frequency domain allocation for the SRS.

Another apparatus for wireless communications at a base station is described. The apparatus may include means for transmitting, to a UE, a downlink control message indicating a time domain allocation for an SRS and a frequency domain allocation for the SRS, and means for monitoring a set of resources for the SRS, the set of resources based on the time domain allocation for the SRS and the frequency domain allocation for the SRS.

A non-transitory computer-readable medium storing code for wireless communications at a base station is described. The code may include instructions executable by a processor to transmit, to a UE, a downlink control message indicating a time domain allocation for an SRS and a frequency domain allocation for the SRS, and monitor a set of resources for the SRS, the set of resources based on the time domain allocation for the SRS and the frequency domain allocation for the SRS.

Some examples of the method, apparatuses, and non-transitory computer-readable medium described herein may further include operations, features, means, or instructions for receiving, from the UE, a capability message that indicates a capability of the UE to support dynamic scheduling of resources for the sounding reference signal.

In some examples of the method, apparatuses, and non-transitory computer-readable medium described herein, monitoring the set of resources may include operations, features, means, or instructions for receiving the SRS over a set of frequency resources of the set of resources based on the frequency domain allocation, where the set of frequency resources may be a truncated set of a total set of frequency resources indicated by the frequency domain allocation.

In some examples of the method, apparatuses, and non-transitory computer-readable medium described herein, monitoring the set of resources may include operations, features, means, or instructions for receiving the SRS using a set of frequency resources of the set of resources based on the frequency domain allocation, where the set of frequency resources includes multiple subsets of consecutive resources in a frequency domain.

Some examples of the method, apparatuses, and non-transitory computer-readable medium described herein may further include operations, features, means, or instructions for transmitting, to the UE, an indication of a reference signal resource configuration for the UE and receiving the SRS using a set of frequency resources of the set of resources based on the frequency domain allocation, where the set of frequency resources includes an integer multiple of RBs indicated by the reference signal resource configuration.

In some examples of the method, apparatuses, and non-transitory computer-readable medium described herein, transmitting the downlink control message may include operations, features, means, or instructions for transmitting one or more bits indicating a bandwidth for the SRS, where monitoring for the SRS may be based on the bandwidth.

In some examples of the method, apparatuses, and non-transitory computer-readable medium described herein, transmitting the downlink control message may include operations, features, means, or instructions for transmitting one or more bits indicating one or more resource configuration parameters for the SRS, where monitoring for the SRS may be in accordance with the one or more resource configuration parameters.

In some examples of the method, apparatuses, and non-transitory computer-readable medium described herein, the one or more resource configuration parameters includes a bandwidth configuration index, a number of RBs, a number of SRSs for transmission, a frequency hopping parameter, or any combination thereof.

In some examples of the method, apparatuses, and non-transitory computer-readable medium described herein, monitoring the set of resources may include operations, features, means, or instructions for receiving the SRS using a set of time resources of the set of resources based on the time domain allocation, where the time domain allocation indicates a starting symbol value for the SRS, a number of symbols for the SRS, a time offset for the SRS, a repetition factor, or any combination thereof.

Some examples of the method, apparatuses, and non-transitory computer-readable medium described herein may further include operations, features, means, or instructions for transmitting a control message indicating a configuration for the UE for receiving the downlink control message.

In some examples of the method, apparatuses, and non-transitory computer-readable medium described herein, the configuration indicates a bitwidth for one or more fields of the downlink control message and the one or more fields indicate the set of resources for the SRS.

In some examples of the method, apparatuses, and non-transitory computer-readable medium described herein, receiving the capability message may include operations, features, means, or instructions for receiving an indication of a supported bandwidth for the SRS, a time offset for the SRS, or any combination thereof.

In some examples of the method, apparatuses, and non-transitory computer-readable medium described herein, transmitting the downlink control message may include operations, features, means, or instructions for transmitting, in the downlink control message, one or more bits indicating an absence of an uplink shared channel transmission via a PUSCH.

In some examples of the method, apparatuses, and non-transitory computer-readable medium described herein, transmitting the downlink control message may include operations, features, means, or instructions for transmitting, in the downlink control message, a FDRA field that indicates the frequency domain allocation.

In some examples of the method, apparatuses, and non-transitory computer-readable medium described herein, transmitting the downlink control message may include operations, features, means, or instructions for transmitting, in the downlink control message, a TDRA field that indicates the time domain allocation

### BRIEF DESCRIPTION OF THE DRAWINGS

FIG. 1 illustrates an example of a wireless communications system that supports enhancement for aperiodic sounding reference signal (A-SRS) scheduling in accordance with aspects of the present disclosure.

FIG. 2 illustrates an example of a wireless communications system that supports enhancement for A-SRS scheduling in accordance with aspects of the present disclosure.

FIG. 3 illustrates an example of a resource diagram that supports enhancement for A-SRS scheduling in accordance with aspects of the present disclosure.

FIG. 4 illustrates an example of a process flow that supports enhancement for A-SRS scheduling in accordance with aspects of the present disclosure.

FIGS. 5 and 6 show block diagrams of devices that support enhancement for A-SRS scheduling in accordance with aspects of the present disclosure.

FIG. 7 shows a block diagram of a communications manager that supports enhancement for A-SRS scheduling in accordance with aspects of the present disclosure.

FIG. 8 shows a diagram of a system including a device that supports enhancement for A-SRS scheduling in accordance with aspects of the present disclosure.

FIGS. 9 and 10 show block diagrams of devices that support enhancement for A-SRS scheduling in accordance with aspects of the present disclosure.

FIG. 11 shows a block diagram of a communications manager that supports enhancement for A-SRS scheduling in accordance with aspects of the present disclosure.

FIG. 12 shows a diagram of a system including a device that supports enhancement for A-SRS scheduling in accordance with aspects of the present disclosure.

FIGS. 13 through 17 show flowcharts illustrating methods that support enhancement for A-SRS scheduling in accordance with aspects of the present disclosure.

### DETAILED DESCRIPTION

In some wireless communications systems, a base station may trigger a user equipment (UE) to transmit one or more reference signals such as aperiodic sounding reference signals (A-SRSs) by transmitting an SRS request in a downlink control information (DCI) message. In some cases, the base station may configure SRS resources for the triggered SRS transmission and indicate the SRS resources via RRC signaling. In some examples, some DCI may have fields of frequency domain resource assignment (FDRA) and time domain resource assignment (TDRA), which, in some cases, may not be used for A-SRS scheduling, resulting in a failure to realize resource efficiency gains as well as limiting A-SRS flexibility.

In some examples, wireless communications systems may support dynamic scheduling of resource allocation for A-SRS transmission. For example, to support dynamic indication of frequency resources for A-SRS transmission, a DCI may indicate an A-SRS frequency resource allocation and an A-SRS time resource allocation for the UE to use to transmit A-SRS. The base station may configure the A-SRS frequency resource allocation (e.g., SRS bandwidth) using an FDRA field in the DCI or using one or more explicit bits, where the UE 115-a may reinterpret the FDRA field in the uplink-DCI. Additionally, in some cases, the base station may configure the A-SRS time resource allocation using a TDRA field in the DCI or using one or more explicit bits, where the UE may reinterpret the TDRA field in the DCI. Upon receiving the resource indication, the UE may identify the A-SRS frequency resource allocation, the A-SRS time resource allocation, or both, and may transmit the A-SRS in accordance with the A-SRS frequency resource allocation and the A-SRS time resource allocation.

In some examples, the UE may transmit capability signaling to the base station, the capability signaling indicating support for a dynamic indication of frequency resources. In such capability signaling, the UE may indicate a minimum supported bandwidth (e.g., A-SRS bandwidth), a time offset (e.g., A-SRS time offset), among other supported features.

Aspects of the disclosure are initially described in the context of wireless communications systems. Aspects of the disclosure are then described in the context of a resource diagram and a process flow. Aspects of the disclosure are further illustrated by and described with reference to apparatus diagrams, system diagrams, and flowcharts that relate to enhancement for A-SRS scheduling.

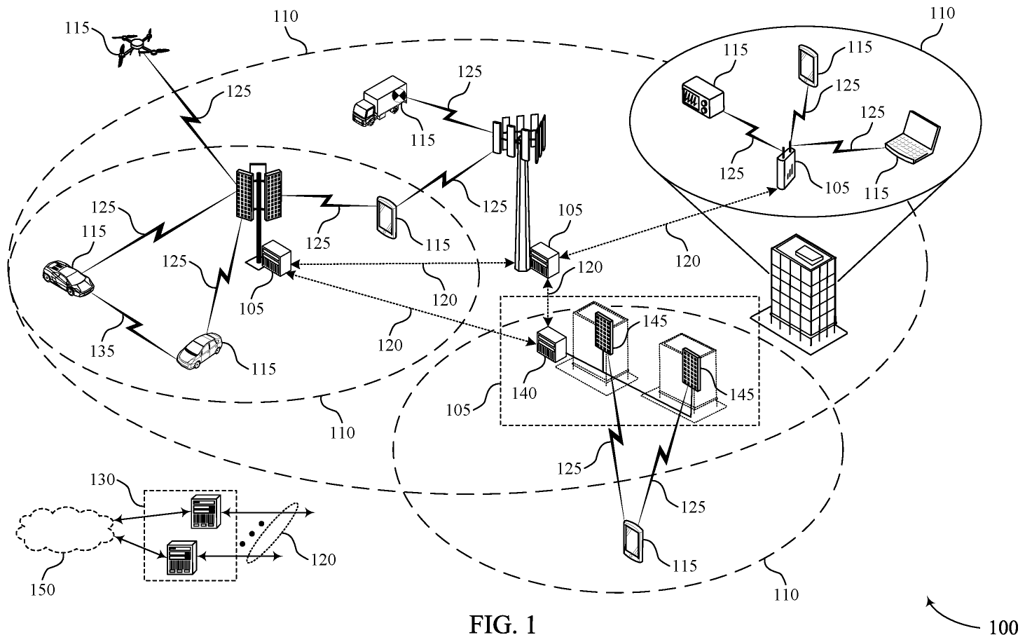

FIG. 1 illustrates an example of a wireless communications system 100 that supports enhancement for A-SRS scheduling in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless communications system 100 may support techniques for flexible A-SRS triggering and resource allocation. For example, a UE 115 may transmit, to a base station 105, a message indicating a capability of the UE 115 to support dynamic resource allocation for A-SRSs. In some examples, the base station 105 may transmit a downlink control message (e.g., DCI, RRC, or MAC-CE) which may indicate time resources, frequency resources, or both for an A-SRS. For instance, the downlink control message may include a time resource allocation (e.g., a TDRA field), a frequency resource allocation (e.g., an FDRA field), one or more bits indicating a bandwidth or other parameters for a resource configuration for A-SRSs, or any combination thereof. The UE 115 may receive the downlink control message and may determine, select, or otherwise identify time-frequency resources to use for transmitting an A-SRS to the base station 105 and transmit the A-SRS using the time-frequency resources.

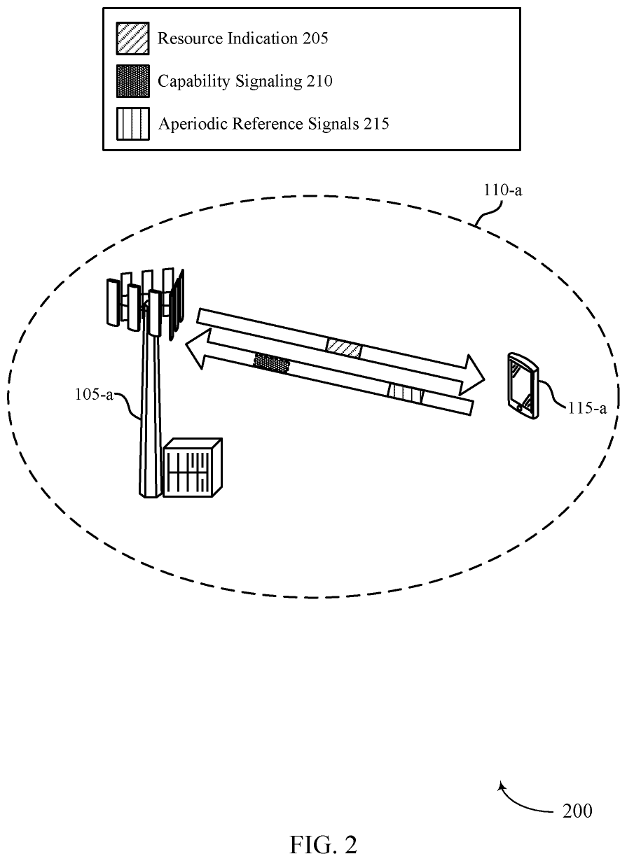

FIG. 2 illustrates an example of a wireless communications system 200 that supports enhancement for A-SRS scheduling in accordance with aspects of the present disclosure. The wireless communications system 200 may implement or be implemented by aspects of the wireless communications system 100. For example, wireless communications system 200 may include a base station 105-a and a UE 115-a which may be examples of corresponding devices as described with reference to FIG. 1. In some examples, the UE 115-a and the base station 105-a may exchange signaling supporting a dynamic A-SRS scheduling procedure.

In some cases, the base station 105-a may trigger the UE 115-a to transmit one or more aperiodic reference signals 215 by transmitting an SRS request in a DCI message. For example, the base station 105-a may transmit a DCI to the UE 115-a, including an SRS request and the UE 115-a may transmit an A-SRS in response to receiving the SRS request. In some cases, the base station 105-a may define SRS resources for the triggered SRS transmission within RRC signaling. For example, the base station 105-a may transmit a resource indication 205 to the UE 115-a indicating one or more resources for the UE 115-a to transmit at least the A-SRS in response to receiving the SRS request. In some cases, the base station 105-a may schedule aperiodic reference signals 215 without scheduling uplink data. That is, the base station 105-a may transmit a single uplink-DCI (e.g., a DCI 0_1 and a DCI 0_2) to schedule (or not schedule) uplink data. For example, the base station 105-a may transmit an uplink-DCI with an uplink-SCH indicator. The uplink-SCH indicator may include a single bit field, where a value of “1” may indicate that uplink-SCH may be transmitted on a physical uplink shared channel (PUSCH) and a value of “0” may indicate that uplink-SCH may not be transmitted on the PUSCH. In such examples, for DCI format 0_1 with CRC scrambled by a SP-CSI-RNTI, the UE 115-a may not be expected to receive a DCI format 0_1 with an uplink-SCH indicator of value “0” and a CSI request of all zero(s).

The base station 105-a may be configured to trigger aperiodic reference signals 215 from the UE 115-a in accordance with one or more trigger states. In some examples, A-SRS trigger states for uplink-DCI 0_1 may be configured for specific CCs scheduled by a corresponding uplink-DCI. As an illustrative example, the base station 105-a may transmit an uplink-DCI to the UE 115-a including an SRS request field to schedule one or more A-SRS transmissions in accordance with Table 1.

TABLE 1

| Value | Triggered aperiodic SRS resource set(s) | Triggered aperiodic SRS resource set(s) |
|---|---|---|
| of SRS | for DCI format 0_1, 1_1, and 2_3 | for DCI format 2_3 configured with |
| request | configured with higher layer parameter | higher layer parameter srs-TPC-PDCCH- |
| field | srs-TPC-PDCCH-Group set to ‘typeB’ | Group set to ‘typeA’ |
| 00 | No aperiodic SRS resource set triggered | No aperiodic SRS resource set triggered |
| 01 | SRS resource set(s) configured with higher | SRS resource set(s) configured with higher |
| | layer parameter aperiodicSRS- | layer parameter usage in SRS-ResourceSet |
| | ResourceTrigger set to 1 | set to ‘antennaSwitching’ and |
| | | ‘resourceType’ in SRS-ResourceSet set to |
| | | ‘aperiodic’ for a 1^{st} set of serving cells |
| | | configured by higher layers |
| 10 | SRS resource set(s) configured with higher | SRS resource set(s) configured with higher |
| | layer parameter aperiodicSRS- | layer parameter usage in SRS-ResourceSet |
| | ResourceTrigger set to 2 | set to ‘antennaSwitching’ and |
| | | ‘resourceType’ in SRS-ResourceSet set to |
| | | ‘aperiodic’ for a 2^{nd} set of serving cells |
| | | configured by higher layers |
| 11 | SRS resource set(s) configured with higher | SRS resource set(s) configured with higher |
| | layer parameter aperiodicSRS- | layer parameter usage in SRS-ResourceSet |
| | ResourceTrigger set to 3 | set to ‘antennaSwitching’ and |
| | | ‘resourceType’ in SRS-ResourceSet set to |
| | | ‘aperiodic’ for a 3^{rd} set of serving cells |
| | | configured by higher layers |

In Table 1, the SRS request field may be a two bit field such that the SRS request field may indicate four distinct SRS configurations. For example, an SRS request field may indicate a value of “00,” indicating no aperiodic SRS resource set being triggered or the SRS request field may indicate a value of “01,” “10,” or “11,” indicating an A-SRS to be triggered on one or more respective resource sets in accordance with Table 1 and the parameters described therein.

As such, A-SRS resources may be configured (e.g., preconfigured by RRC signaling) and up to four A-SRS trigger states may be triggered by DCI (e.g., with reference to the four distinct SRS request field values). To support sounding a large variety of frequency locations in uplink, A-SRS may be configured with multiple frequency hopping options. However, such frequency hopping may be limited due to a lack of flexibility associated with A-SRS transmissions. In some examples, uplink-DCI may have fields of FDRA and TDRA, which, in some cases, may not be used for A-SRS, resulting in a failure to realize resource efficiency gains, limited A-SRS flexibility, or both.

In some examples, wireless communications system 200 may support dynamic scheduling of resource allocation for A-SRS transmission. For example, to support dynamic indication of frequency resources for A-SRS transmission, an uplink-DCI (e.g., DCI format 0_1 and DCI format 0_2), such as the resource indication 205, may indicate an A-SRS frequency resource allocation and an A-SRS time resource allocation when no uplink data is scheduled. In other words, the base station 105-a may transmit an uplink-DCI to the UE 115-a indicating an A-SRS frequency resource allocation and an A-SRS time resource allocation while setting an uplink-SCH field to the value “0.” The base station 105-a may configure the A-SRS frequency resource allocation (e.g., SRS bandwidth) using an FDRA field in the uplink-DCI or using one or more explicit bits, where the UE 115-a may reinterpret the FDRA field in the uplink-DCI. In such cases, the base station 105-a may transmit the resource indication 205 including the A-SRS frequency resource allocation. Additionally, in some cases, the base station 105-a may configure the A-SRS time resource allocation using a TDRA field in the uplink-DCI or using one or more explicit bits, where the UE 115-a may reinterpret the TDRA field in the uplink-DCI. As such, the base station 105-a may transmit the resource indication 205 including the A-SRS time resource allocation.

Upon receiving the resource indication 205, the UE 115-a may identify the A-SRS frequency resource allocation, the A-SRS time resource allocation, or both, and may transmit the aperiodic reference signals 215 (e.g., A-SRS) in accordance with the A-SRS frequency resource allocation and the A-SRS time resource allocation.

In some examples, the UE 115-a may transmit capability signaling 210, the capability signaling indicating support for a dynamic indication of frequency resources (e.g., the A-SRS frequency resource allocation). Additionally, the UE 115-a may indicate a minimum supported bandwidth (e.g., A-SRS bandwidth), a time offset (e.g., A-SRS time offset), among other supported features. In some examples, the UE 115-a may be configured to receive the dynamic indication of the frequency resources for A-SRS transmission from a uplink-DCI (e.g., DCI format 0_1 and DCI format 0_2). The configuration may be based on RRC signaling such as with an enablement field (e.g., “dynamic-allocation-for-A-SRS”). In response to receiving such a configuration, the UE 115-a may expect to receive an indication of frequency resources for A-SRS transmission (e.g., the A-SRS frequency resource allocation). In some examples, the configuration may also configure a bitwidth for one or more DCI fields. For example, the DCI field may have a field for a b-SRS parameter and a field for a c-SRS parameter, where the b-SRS parameter and the c-SRS parameter may be used to determine a resource assignment for SRS transmission. In some examples, the UE 115-a may receive the DCI including the b-SRS parameter and the c-SRS parameter, where the UE 115-a may use the b-SRS parameter and the c-SRS parameter to identify a resource assignment for A-SRS transmission, for example, using a look-up table known to wireless devices. In some examples, the base station 105-a may transmit the DCI reconfiguring bitwidths for the b-SRS parameter field and the c-SRS parameter field. For example, the DCI field for a c-SRS parameter may be configured as 6-bits and the DCI field for a b-SRS parameter may be configured as 4-bits.

Configuring wireless devices to support dynamic indications for frequency resources, time resources, or both, may enhance resource efficiency, for example, by increasing resource allocation flexibility.

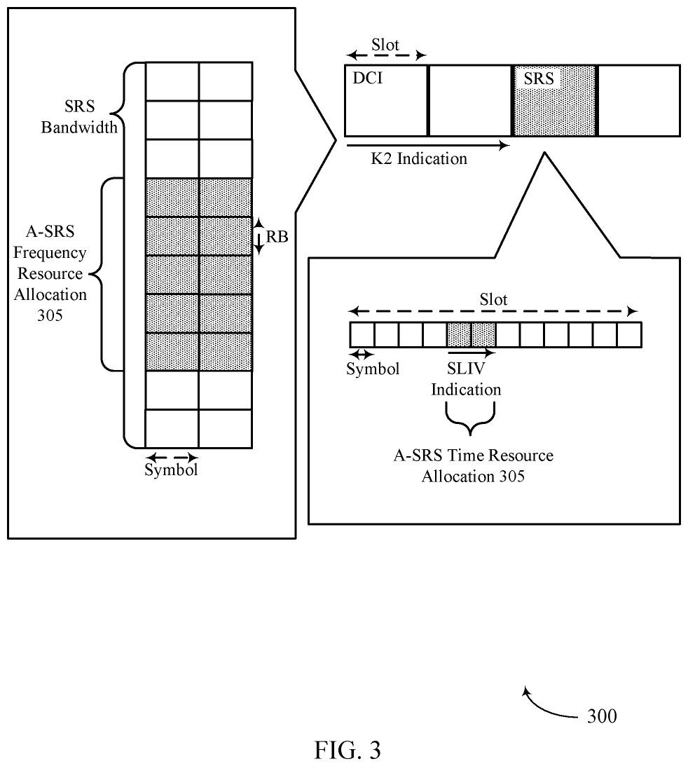

FIG. 3 illustrates an example of a resource diagram 300 that supports enhancement for A-SRS scheduling in accordance with aspects of the present disclosure. In some examples, the resource diagram may be implemented by aspects of wireless communications system 100 or wireless communications system 200. In this example, a base station may transmit a dynamic resource indication, such as resource indication 205 as described with reference to FIG. 2, to a UE, configuring the UE with A-SRS resources.

In some examples, to support dynamic indication of frequency resources for A-SRS transmission, the base station may transmit a uplink-DCI to indicate an A-SRS frequency resource allocation 305, an A-SRS time resource allocation 310, or both, when no uplink data is scheduled. For example, the base station may indicate an actual transmitted A-SRS frequency resource allocation 305 using an FDRA field in the uplink-DCI. In such examples, the UE may transmit A-SRS on the configured A-SRS resources indicated by the FDRA field in the uplink-DCI. For example, in the case of resource diagram 300, the FDRA field may indicate that the A-SRS frequency resource allocation 305 is five RBs. In some examples, FDRA for A-SRS may be subject to one or more constraints. For example, the allocated FDRA for an SRS may be a multiple of 4 RBs in accordance with SRS resource configurations. In some examples, the uplink-DCI may truncate the configured A-SRS resources for the actual A-SRS transmission (e.g., in accordance with the one or more constraints). For example, the base station may configure the A-SRS frequency resource allocation 305 with 50 RBs, however, the allocated FDRA for an SRS may be a multiple of 4 RBs. In such an example, the uplink-DCI may truncate the configured A-SRS frequency resource allocation 305 with 48 RBs. Additionally, in some cases, the UE may expect the FDRA in uplink-DCI to be consecutive in uplink (e.g., consecutive RBs). In some examples, the base station may indicate an actual transmitted A-SRS frequency resource allocation 305 using a reinterpretation of the FDRA field assignment in the uplink-DCI (e.g., using explicit bits). In some cases, the DCI may dynamically indicate the parameter value of a c-SRS field and a b-SRS field for the A-SRS. For example, the DCI may indicate 6-bits for a c-SRS parameter and 2-bits for a b-SRS parameter. In some cases, the DCI may dynamically indicate whether frequency hopping may be enabled, for example, using a 2-bit field in a b-hop parameter.

In some examples, the base station may indicate a starting time and a duration of the A-SRS time resource allocation 310 using the TDRA field in the uplink-DCI. For example, the uplink-DCI may include an SLIV field and a K2 field supporting the TDRA indication. As such, the base station may signal an SLIV value to indicate a starting position (e.g., startPosition) by the S value and a duration (e.g., nrofSymbols) by the L value for A-SRS transmissions. Additionally, the base station may signal a K2 value to indicate a slot offset of A-SRS from the triggering DCI. For example, in resource configuration 300, the base station may use the K2 value to indicate the A-SRS transmission to be in the second slot after the slot containing an A-SRS triggering DCI. In such an example, the base station may use the SLIV value to configure the A-SRS transmission to start in the fifth symbol in the slot indicated by the K2 field and with a duration of two symbols. In some examples, the base station may use explicit DCI bits to indicate the TDRA of A-SRS, for example, reinterpreting the TDRA field in uplink-DCI to configure the A-SRS time resource allocation 310. For example, the uplink-DCI may indicate three bits for a start position (e.g., startPosition), two bits for symbol duration (e.g., nrofSymbols), and two bits for repetitions (e.g., repetitionFactor). That is, the base station may reconfigure the bits associated with the TDRA field in the uplink-DCI to support dynamic A-SRS transmissions. In another example, the uplink-DCI may indicate 4 bits to indicate the A-SRS time resource allocation 310 and 2 bits for repetitions.

The techniques as described herein may provide for a more flexible assignment for A-SRS resources, resulting in more efficient communication resource utilization, better coordination between devices, and in some cases, reduced system latency due to expedited A-SRS resource assignment.

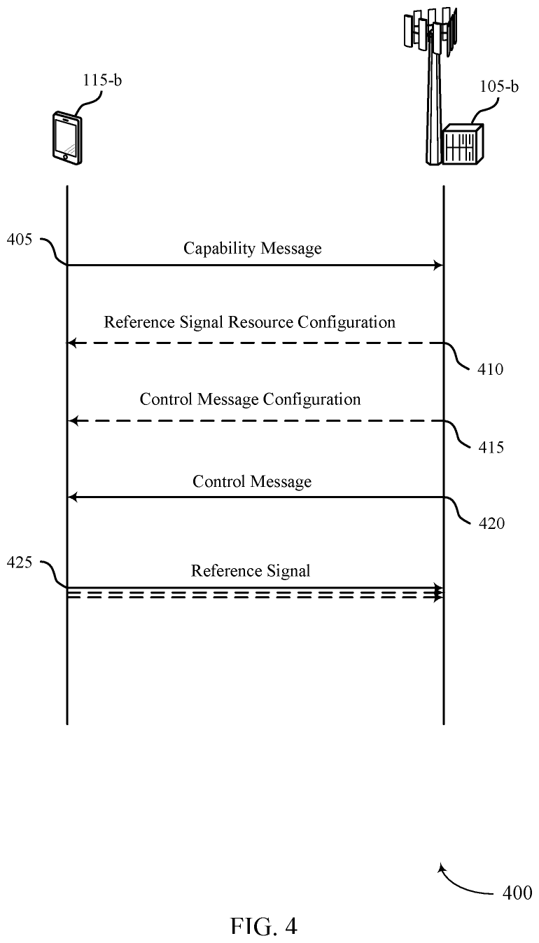

FIG. 4 illustrates an example of a process flow 400 that supports enhancement for A-SRS scheduling in accordance with aspects of the present disclosure. In some examples, the process flow 400 may implement aspects of wireless communications systems 100 or 200. For example, process flow 400 may include UE 115-b and base station 105-b, which may be examples of corresponding devices as described with reference to FIGS. 1 and 2. In some examples, the UE 115-b and the base station 105-b may exchange signaling with one another to dynamically schedule A-SRS transmissions from the UE 115-b.

In the following description of the process flow 400, the operations may be performed (e.g., reported or provided) in a different order than the order shown, or the operations performed by the UE 115-b and the base station 105-b may be performed in different orders or at different times. For example, specific operations also may be left out of the process flow 400, or other operations may be added to the process flow 400. Further, although some operations or signaling may be shown to occur at different times for discussion purposes, these operations may actually occur at the same time.

At 405, the UE 115-b may transmit, to the base station 105-b, a capability message that indicates a capability of the UE 115-b to support dynamic scheduling of resources for an SRS (e.g., an A-SRS scheduled in accordance with techniques as described herein). For example, the UE 115-b may transmit capability signaling 210 to the base station 105-b as described with reference to FIG. 2. In some examples, transmitting the capability message may include transmitting an indication of a supported bandwidth for the SRS, a time offset for the SRS, or a combination thereof.

In some examples, at 410, the base station 105-b may transmit, and the UE 115-b may receive a reference signal resource configuration for the UE 115-b. In such cases, the reference signal resource configuration may include a number of RBs for the UE 115-b to reference, or otherwise use, for SRS transmission.

In some examples, at 415, the base station 105-b may transmit, and the UE 115-b may receive, a control message indicating a configuration (e.g., a control message configuration) for the UE 115-b for receiving a control message (e.g., a DCI such as a DCI including resource indication 205 as described with reference to FIG. 2). In some examples, the configuration may indicate a bitwidth for one or more fields of the control message (e.g., a b-SRS parameter field, a c-SRS parameter field), where the one or more fields may indicate a set of resources for SRS transmissions.

At 420, the base station 105-b may transmit, and the UE 115-b may receive, in response to the capability message at 405, a control message indicating a time domain allocation for the SRS and a frequency domain allocation for the SRS. For example, the UE 115-b may receive a DCI including an indication the time domain allocation for the SRS and a frequency domain allocation for the SRS. In some examples, receiving the DCI may include receiving one or more bits indicating a bandwidth for the SRS (e.g., an A-SRS frequency resource allocation 305 as described with reference to FIG. 3). In some examples, receiving the DCI may include receiving one or more bits indicating one or more resource configuration parameters (e.g., a b-SRS parameter, a c-SRS parameter) for the SRS. In such examples, the one or more resource configuration parameters may include a bandwidth configuration index (e.g., an index associated with an SRS resource table), a number of RBs, a number of SRSs for transmission, a frequency hopping parameter, or a combination thereof. In some examples, receiving the DCI may include receiving, in the DCI, one or more bits indicating an absence of an uplink shared channel transmission via a PUSCH. That is, the DCI may include an indication notifying the UE 115-b to refrain from transmitting an uplink shared channel transmission (e.g., an uplink_SCH field may be set to “0”). In some examples, receiving the DCI may include receiving, in the DCI, an FDRA field that may indicate the frequency domain allocation. Additionally, receiving the DCI may include receiving, in the DCI, a TDRA field, that may indicate the time domain allocation.

At 425, the UE 115-b may transmit, and the base station 105-b may receive the SRS using a set of resources, in response to the DCI at 420, the set of resources selected based at least in part on the time domain allocation for the SRS and the frequency domain allocation for the SRS. In some examples, the set of resources may be a truncated set of a total set of frequency resource indicated by the frequency domain allocation. For example, the frequency domain allocation may indicate 50 RBs for the UE 115-b to transmit SRS, where the UE 115-b may truncate the total set of frequency resources to 48 RBs. In some examples, the set of frequency resources may include multiple subsets of consecutive resources in a frequency domain. For example, the UE 115-b may transmit the SRS using a first group of consecutive (e.g., in the frequency domain) RBs and may transmit the SRS using a second group of consecutive (e.g., in the frequency domain) RBs. In some examples, the set of frequency resources may include an integer multiple of RBs which may be indicated by the reference signal resource configuration at 410. In some examples, the UE 115-b may transmit the SRS using the bandwidth, the one or more resource configuration parameters, or a combination thereof, as indicted in the control message at 420. In some examples, transmitting the SRS using a set of time resource of the set of resources may be based in part on the time domain allocation, where the time domain allocation may indicate a starting symbol value for the SRS, a number of symbols for the SRS, a time offset for the SRS, a repetition factor, or a combination thereof.

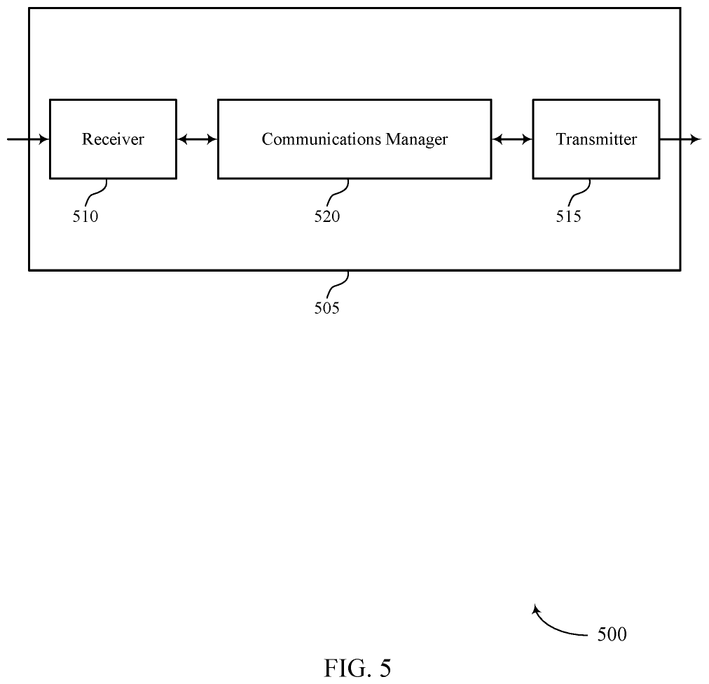

FIG. 5 shows a block diagram 500 of a device 505 that supports enhancement for A-SRS scheduling in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to enhancement for A-SRS scheduling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhancement for A-SRS scheduling). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of enhancement for A-SRS scheduling as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for transmitting, to a base station, a capability message that indicates a capability of the UE to support dynamic scheduling of resources for a sounding reference signal. The communications manager 520 may be configured as or otherwise support a means for receiving, from the base station in response to the capability message, a downlink control message indicating a time domain allocation for the sounding reference signal and a frequency domain allocation for the sounding reference signal. The communications manager 520 may be configured as or otherwise support a means for transmitting the sounding reference signal using a set of resources in response to the downlink control message, the set of resources selected based on the time domain allocation for the sounding reference signal and the frequency domain allocation for the sounding reference signal.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for dynamic A-SRS scheduling, resulting in more efficient utilization of communication resources.

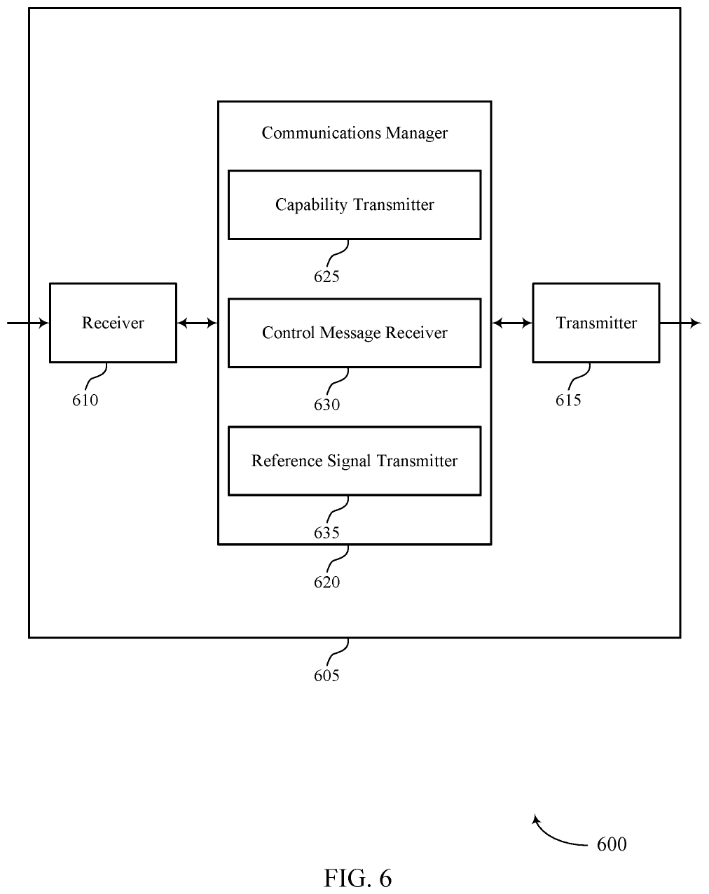

FIG. 6 shows a block diagram 600 of a device 605 that supports enhancement for A-SRS scheduling in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to enhancement for A-SRS scheduling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhancement for A-SRS scheduling). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enhancement for A-SRS scheduling as described herein. For example, the communications manager 620 may include a capability transmitter 625, a control message receiver 630, a reference signal transmitter 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The capability transmitter 625 may be configured as or otherwise support a means for transmitting, to a base station, a capability message that indicates a capability of the UE to support dynamic scheduling of resources for a sounding reference signal. The control message receiver 630 may be configured as or otherwise support a means for receiving, from the base station in response to the capability message, a downlink control message indicating a time domain allocation for the sounding reference signal and a frequency domain allocation for the sounding reference signal. The reference signal transmitter 635 may be configured as or otherwise support a means for transmitting the sounding reference signal using a set of resources in response to the downlink control message, the set of resources selected based on the time domain allocation for the sounding reference signal and the frequency domain allocation for the sounding reference signal.

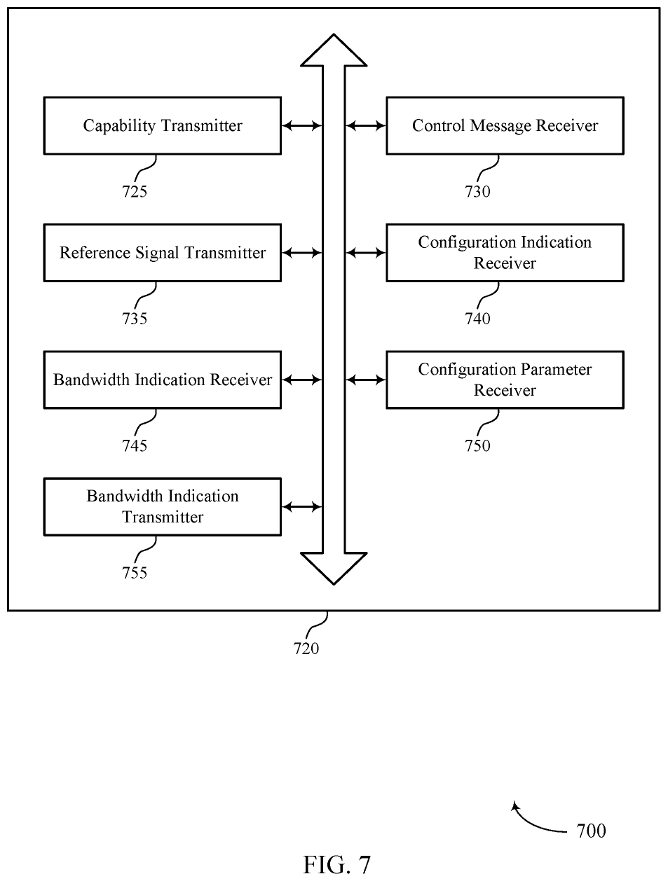

FIG. 7 shows a block diagram 700 of a communications manager 720 that supports enhancement for A-SRS scheduling in accordance with aspects of the present disclosure. The communications manager 720 may be an example of aspects of a communications manager 520, a communications manager 620, or both, as described herein. The communications manager 720, or various components thereof, may be an example of means for performing various aspects of enhancement for A-SRS scheduling as described herein. For example, the communications manager 720 may include a capability transmitter 725, a control message receiver 730, a reference signal transmitter 735, a configuration indication receiver 740, a bandwidth indication receiver 745, a configuration parameter receiver 750, a bandwidth indication transmitter 755, or any combination thereof. Each of these components may communicate, directly or indirectly, with one another (e.g., via one or more buses).

The communications manager 720 may support wireless communications at a UE in accordance with examples as disclosed herein. The capability transmitter 725 may be configured as or otherwise support a means for transmitting, to a base station, a capability message that indicates a capability of the UE to support dynamic scheduling of resources for a sounding reference signal. The control message receiver 730 may be configured as or otherwise support a means for receiving, from the base station in response to the capability message, a downlink control message indicating a time domain allocation for the sounding reference signal and a frequency domain allocation for the sounding reference signal. The reference signal transmitter 735 may be configured as or otherwise support a means for transmitting the sounding reference signal using a set of resources in response to the downlink control message, the set of resources selected based on the time domain allocation for the sounding reference signal and the frequency domain allocation for the sounding reference signal.

In some examples, to support transmitting the sounding reference signal, the reference signal transmitter 735 may be configured as or otherwise support a means for transmitting the sounding reference signal using a set of frequency resources of the set of resources based on the frequency domain allocation, where the set of frequency resources is a truncated set of a total set of frequency resources indicated by the frequency domain allocation.

In some examples, to support transmitting the sounding reference signal, the reference signal transmitter 735 may be configured as or otherwise support a means for transmitting the sounding reference signal using a set of frequency resources of the set of resources based on the frequency domain allocation, where the set of frequency resources includes multiple subsets of consecutive resources in a frequency domain.

In some examples, the configuration indication receiver 740 may be configured as or otherwise support a means for receiving, from the base station, an indication of a reference signal resource configuration for the UE. In some examples, the reference signal transmitter 735 may be configured as or otherwise support a means for transmitting the sounding reference signal using a set of frequency resources of the set of resources based on the frequency domain allocation, where the set of frequency resources includes an integer multiple of RBs indicated by the reference signal resource configuration.

In some examples, to support receiving the downlink control message, the bandwidth indication receiver 745 may be configured as or otherwise support a means for receiving one or more bits indicating a bandwidth for the sounding reference signal, where the sounding reference signal is transmitted using the bandwidth.

In some examples, to support receiving the downlink control message, the configuration parameter receiver 750 may be configured as or otherwise support a means for receiving one or more bits indicating one or more resource configuration parameters for the sounding reference signal, where the sounding reference signal is transmitted in accordance with the one or more resource configuration parameters.

In some examples, the one or more resource configuration parameters includes a bandwidth configuration index, a number of RBs, a number of sounding reference signals for transmission, a frequency hopping parameter, or any combination thereof.

In some examples, to support transmitting the sounding reference signal, the reference signal transmitter 735 may be configured as or otherwise support a means for transmitting the sounding reference signal using a set of time resources of the set of resources based on the time domain allocation, where the time domain allocation indicates a starting symbol value for the sounding reference signal, a number of symbols for the sounding reference signal, a time offset for the sounding reference signal, a repetition factor, or any combination thereof.

In some examples, the control message receiver 730 may be configured as or otherwise support a means for receiving a control message indicating a configuration for the UE for receiving the downlink control message.

In some examples, the configuration indicates a bitwidth for one or more fields of the downlink control message. In some examples, the one or more fields indicate the set of resources for the sounding reference signal.

In some examples, to support transmitting the capability message, the bandwidth indication transmitter 755 may be configured as or otherwise support a means for transmitting an indication of a supported bandwidth for the sounding reference signal, a time offset for the sounding reference signal, or any combination thereof.

In some examples, to support receiving the downlink control message, the control message receiver 730 may be configured as or otherwise support a means for receiving, in the downlink control message, one or more bits indicating an absence of an uplink shared channel transmission via a physical uplink shared channel.

In some examples, to support receiving the downlink control message, the control message receiver 730 may be configured as or otherwise support a means for receiving, in the downlink control message, a FDRA field that indicates the frequency domain allocation.

In some examples, to support receiving the downlink control message, the control message receiver 730 may be configured as or otherwise support a means for receiving, in the downlink control message, a TDRA field that indicates the time domain allocation.

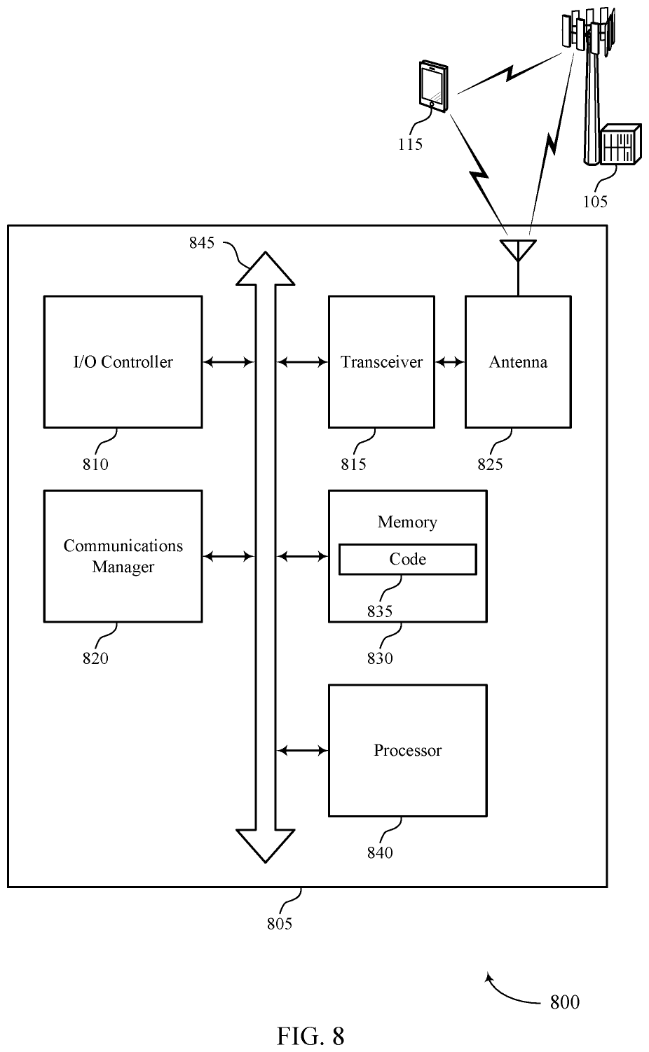

FIG. 8 shows a diagram of a system 800 including a device 805 that supports enhancement for A-SRS scheduling in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting enhancement for A-SRS scheduling). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting, to a base station, a capability message that indicates a capability of the UE to support dynamic scheduling of resources for a sounding reference signal. The communications manager 820 may be configured as or otherwise support a means for receiving, from the base station in response to the capability message, a downlink control message indicating a time domain allocation for the sounding reference signal and a frequency domain allocation for the sounding reference signal. The communications manager 820 may be configured as or otherwise support a means for transmitting the sounding reference signal using a set of resources in response to the downlink control message, the set of resources selected based on the time domain allocation for the sounding reference signal and the frequency domain allocation for the sounding reference signal.

By including or configuring the communications manager 820 in accordance with examples as described herein, the device 805 may support techniques dynamic A-SRS scheduling, resulting in improved communication reliability, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of enhancement for A-SRS scheduling as described herein, or the processor 840 and the memory 830 may be otherwise configured to perform or support such operations.

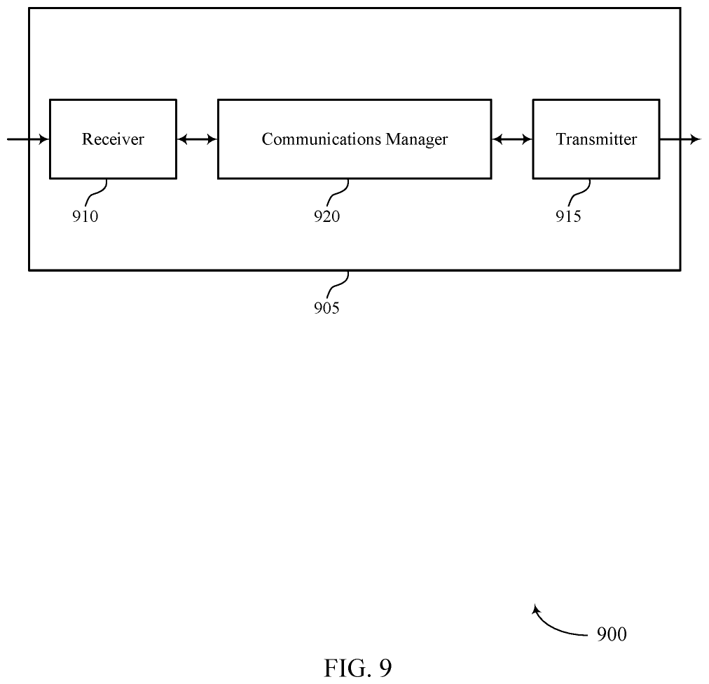

FIG. 9 shows a block diagram 900 of a device 905 that supports enhancement for A-SRS scheduling in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to enhancement for A-SRS scheduling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to enhancement for A-SRS scheduling). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of enhancement for A-SRS scheduling as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for receiving, from a UE, a capability message that indicates a capability of the UE to support dynamic scheduling of resources for a sounding reference signal. The communications manager 920 may be configured as or otherwise support a means for transmitting, to the UE and in response to the capability message, a downlink control message indicating a time domain allocation for the sounding reference signal and a frequency domain allocation for the sounding reference signal. The communications manager 920 may be configured as or otherwise support a means for monitoring a set of resources for the sounding reference signal, the set of resources based on the time domain allocation for the sounding reference signal and the frequency domain allocation for the sounding reference signal.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for dynamic A-SRS scheduling, resulting in more efficient utilization of communication resources.

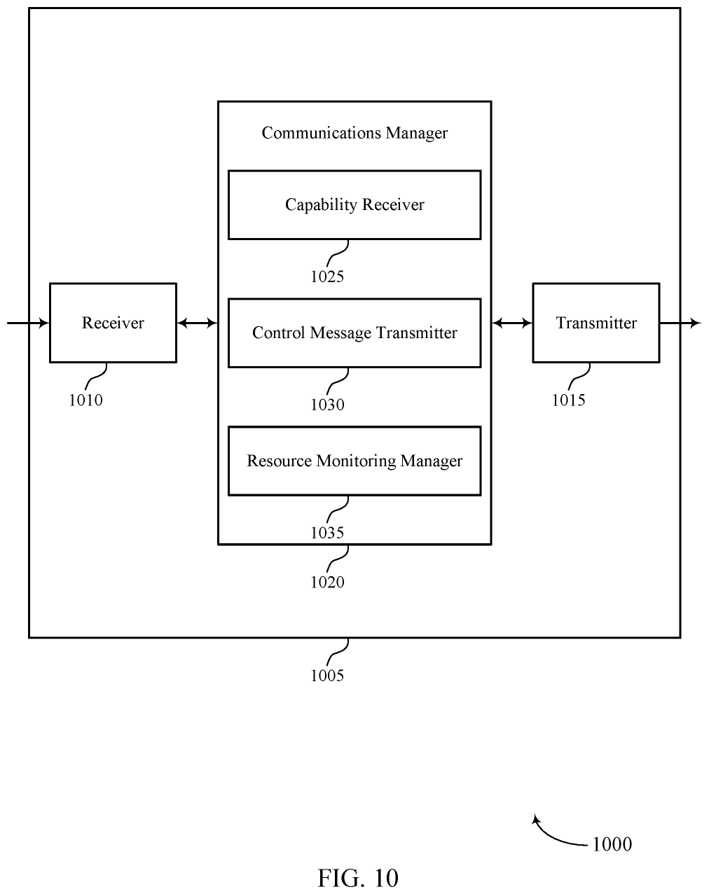

FIG. 10 shows a block diagram 1000 of a device 1005 that supports enhancement for A-SRS scheduling in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to enhancement for A-SRS scheduling). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to enhancement for A-SRS scheduling). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of enhancement for A-SRS scheduling as described herein. For example, the communications manager 1020 may include a capability receiver 1025, a control message transmitter 1030, a resource monitoring manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The capability receiver 1025 may be configured as or otherwise support a means for receiving, from a UE, a capability message that indicates a capability of the UE to support dynamic scheduling of resources for a sounding reference signal. The control message transmitter 1030 may be configured as or otherwise support a means for transmitting, to the UE and in response to the capability message, a downlink control message indicating a time domain allocation for the sounding reference signal and a frequency domain allocation for the sounding reference signal. The resource monitoring manager 1035 may be configured as or otherwise support a means for monitoring a set of resources for the sounding reference signal, the set of resources based on the time domain allocation for the sounding reference signal and the frequency domain allocation for the sounding reference signal.

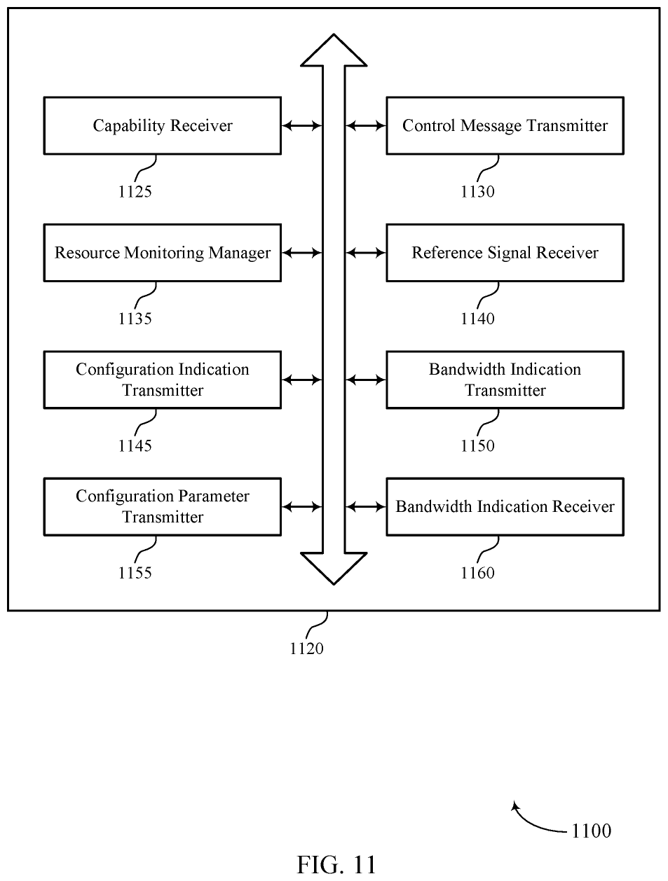

FIG. 11 shows a block diagram 1100 of a communications manager 1120 that supports enhancement for A-SRS scheduling in accordance with aspects of the present disclosure. The communications manager 1120 may be an example of aspects of a communications manager 920, a communications manager 1020, or both, as described herein. The communications manager 1120, or various components thereof, may be an example of means for performing various aspects of enhancement for A-SRS scheduling as described herein. For example, the communications manager 1120 may include a capability receiver 1125, a control message transmitter 1130, a resource monitoring manager 1135, a reference signal receiver 1140, a configuration indication transmitter 1145, a bandwidth indication transmitter 1150, a configuration parameter transmitter 1155, a bandwidth indication receiver 1160, or any combination thereof. Each of these components may communicate, directly or indirectly, with one another (e.g., via one or more buses).

The communications manager 1120 may support wireless communications at a base station in accordance with examples as disclosed herein. The capability receiver 1125 may be configured as or otherwise support a means for receiving, from a UE, a capability message that indicates a capability of the UE to support dynamic scheduling of resources for a sounding reference signal. The control message transmitter 1130 may be configured as or otherwise support a means for transmitting, to the UE and in response to the capability message, a downlink control message indicating a time domain allocation for the sounding reference signal and a frequency domain allocation for the sounding reference signal. The resource monitoring manager 1135 may be configured as or otherwise support a means for monitoring a set of resources for the sounding reference signal, the set of resources based on the time domain allocation for the sounding reference signal and the frequency domain allocation for the sounding reference signal.

In some examples, to support monitoring the set of resources, the reference signal receiver 1140 may be configured as or otherwise support a means for receiving the sounding reference signal over a set of frequency resources of the set of resources based on the frequency domain allocation, where the set of frequency resources is a truncated set of a total set of frequency resources indicated by the frequency domain allocation.

In some examples, to support monitoring the set of resources, the reference signal receiver 1140 may be configured as or otherwise support a means for receiving the sounding reference signal using a set of frequency resources of the set of resources based on the frequency domain allocation, where the set of frequency resources includes multiple subsets of consecutive resources in a frequency domain.

In some examples, the configuration indication transmitter 1145 may be configured as or otherwise support a means for transmitting, to the UE, an indication of a reference signal resource configuration for the UE. In some examples, the reference signal receiver 1140 may be configured as or otherwise support a means for receiving the sounding reference signal using a set of frequency resources of the set of resources based on the frequency domain allocation, where the set of frequency resources includes an integer multiple of RBs indicated by the reference signal resource configuration.

In some examples, to support transmitting the downlink control message, the bandwidth indication transmitter 1150 may be configured as or otherwise support a means for transmitting one or more bits indicating a bandwidth for the sounding reference signal, where monitoring for the sounding reference signal is based on the bandwidth.

In some examples, to support transmitting the downlink control message, the configuration parameter transmitter 1155 may be configured as or otherwise support a means for transmitting one or more bits indicating one or more resource configuration parameters for the sounding reference signal, where monitoring for the sounding reference signal is in accordance with the one or more resource configuration parameters.

In some examples, the one or more resource configuration parameters includes a bandwidth configuration index, a number of RBs, a number of sounding reference signals for transmission, a frequency hopping parameter, or any combination thereof.

In some examples, to support monitoring the set of resources, the reference signal receiver 1140 may be configured as or otherwise support a means for receiving the sounding reference signal using a set of time resources of the set of resources based on the time domain allocation, where the time domain allocation indicates a starting symbol value for the sounding reference signal, a number of symbols for the sounding reference signal, a time offset for the sounding reference signal, a repetition factor, or any combination thereof.

In some examples, the control message transmitter 1130 may be configured as or otherwise support a means for transmitting a control message indicating a configuration for the UE for receiving the downlink control message.

In some examples, the configuration indicates a bitwidth for one or more fields of the downlink control message. In some examples, the one or more fields indicate the set of resources for the sounding reference signal.

In some examples, to support receiving the capability message, the bandwidth indication receiver 1160 may be configured as or otherwise support a means for receiving an indication of a supported bandwidth for the sounding reference signal, a time offset for the sounding reference signal, or any combination thereof.

In some examples, to support transmitting the downlink control message, the control message transmitter 1130 may be configured as or otherwise support a means for transmitting, in the downlink control message, one or more bits indicating an absence of an uplink shared channel transmission via a physical uplink shared channel.

In some examples, to support transmitting the downlink control message, the control message transmitter 1130 may be configured as or otherwise support a means for transmitting, in the downlink control message, a FDRA field that indicates the frequency domain allocation.

In some examples, to support transmitting the downlink control message, the control message transmitter 1130 may be configured as or otherwise support a means for transmitting, in the downlink control message, a TDRA field that indicates the time domain allocation.

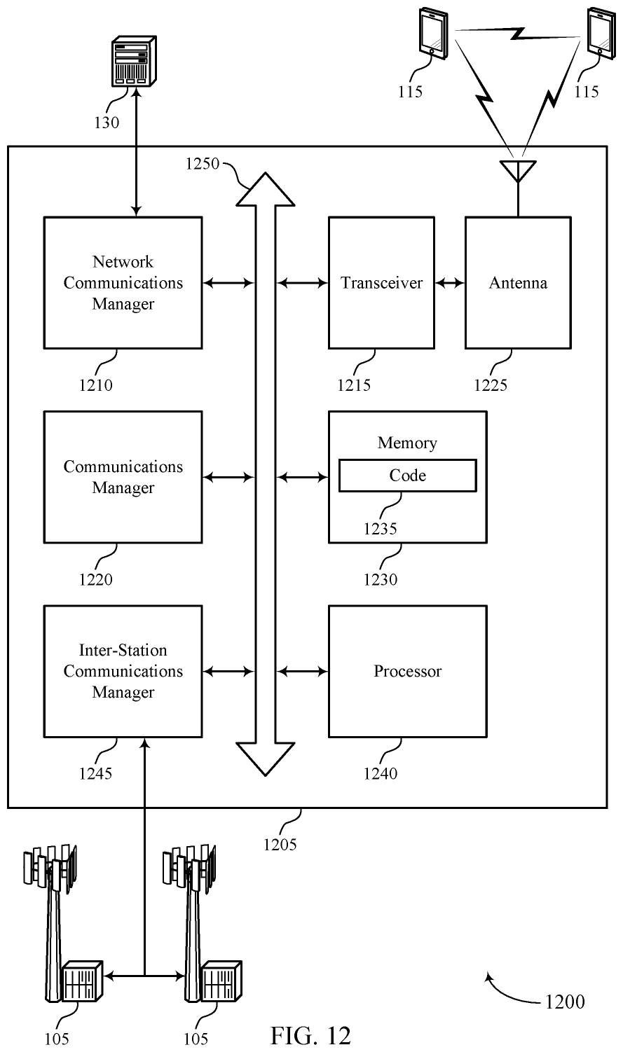

FIG. 12 shows a diagram of a system 1200 including a device 1205 that supports enhancement for A-SRS scheduling in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting enhancement for A-SRS scheduling). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for receiving, from a UE, a capability message that indicates a capability of the UE to support dynamic scheduling of resources for a sounding reference signal. The communications manager 1220 may be configured as or otherwise support a means for transmitting, to the UE and in response to the capability message, a downlink control message indicating a time domain allocation for the sounding reference signal and a frequency domain allocation for the sounding reference signal. The communications manager 1220 may be configured as or otherwise support a means for monitoring a set of resources for the sounding reference signal, the set of resources based on the time domain allocation for the sounding reference signal and the frequency domain allocation for the sounding reference signal.

By including or configuring the communications manager 1220 in accordance with examples as described herein, the device 1205 may support techniques for dynamic A-SRS scheduling, resulting in improved communication reliability, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of enhancement for A-SRS scheduling as described herein, or the processor 1240 and the memory 1230 may be otherwise configured to perform or support such operations.

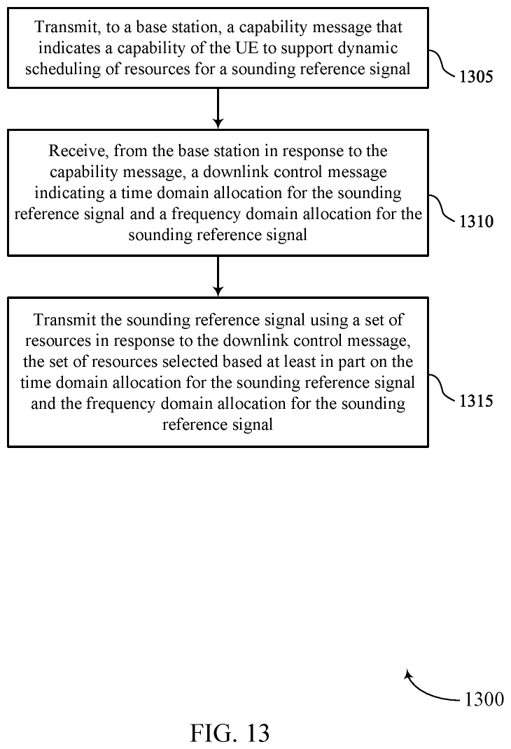

FIG. 13 shows a flowchart illustrating a method 1300 that supports enhancement for A-SRS scheduling in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include transmitting, to a base station, a capability message that indicates a capability of the UE to support dynamic scheduling of resources for a sounding reference signal. The operations of 1305 may be performed in accordance with examples as disclosed herein. In some examples, aspects of the operations of 1305 may be performed by a capability transmitter 725 as described with reference to FIG. 7.

At 1310, the method may include receiving, from the base station in response to the capability message, a downlink control message indicating a time domain allocation for the sounding reference signal and a frequency domain allocation for the sounding reference signal. The operations of 1310 may be performed in accordance with examples as disclosed herein. In some examples, aspects of the operations of 1310 may be performed by a control message receiver 730 as described with reference to FIG. 7.

At 1315, the method may include transmitting the sounding reference signal using a set of resources in response to the downlink control message, the set of resources selected based on the time domain allocation for the sounding reference signal and the frequency domain allocation for the sounding reference signal. The operations of 1315 may be performed in accordance with examples as disclosed herein. In some examples, aspects of the operations of 1315 may be performed by a reference signal transmitter 735 as described with reference to FIG. 7.

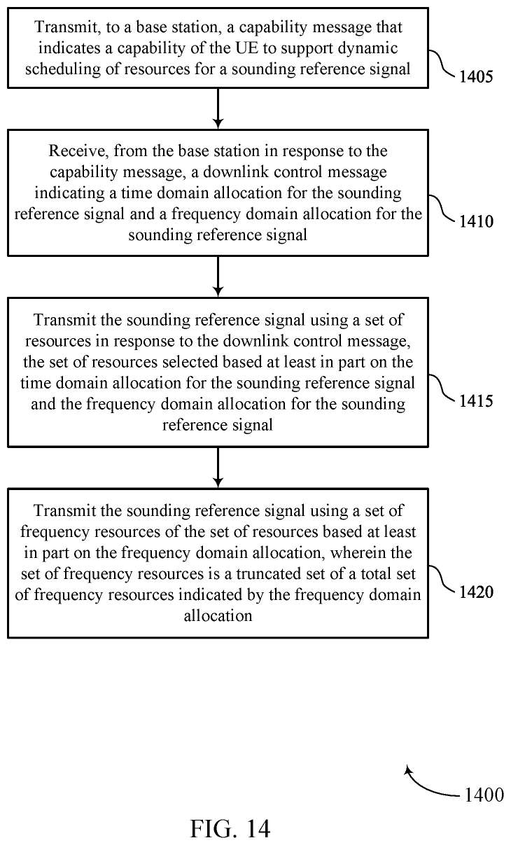

FIG. 14 shows a flowchart illustrating a method 1400 that supports enhancement for A-SRS scheduling in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include transmitting, to a base station, a capability message that indicates a capability of the UE to support dynamic scheduling of resources for a sounding reference signal. The operations of 1405 may be performed in accordance with examples as disclosed herein. In some examples, aspects of the operations of 1405 may be performed by a capability transmitter 725 as described with reference to FIG. 7.

At 1410, the method may include receiving, from the base station in response to the capability message, a downlink control message indicating a time domain allocation for the sounding reference signal and a frequency domain allocation for the sounding reference signal. The operations of 1410 may be performed in accordance with examples as disclosed herein. In some examples, aspects of the operations of 1410 may be performed by a control message receiver 730 as described with reference to FIG. 7.

At 1415, the method may include transmitting the sounding reference signal using a set of resources in response to the downlink control message, the set of resources selected based on the time domain allocation for the sounding reference signal and the frequency domain allocation for the sounding reference signal. The operations of 1415 may be performed in accordance with examples as disclosed herein. In some examples, aspects of the operations of 1415 may be performed by a reference signal transmitter 735 as described with reference to FIG. 7.

At 1420, the method may include transmitting the sounding reference signal using a set of frequency resources of the set of resources based on the frequency domain allocation, where the set of frequency resources is a truncated set of a total set of frequency resources indicated by the frequency domain allocation. The operations of 1420 may be performed in accordance with examples as disclosed herein. In some examples, aspects of the operations of 1420 may be performed by a reference signal transmitter 735 as described with reference to FIG. 7.

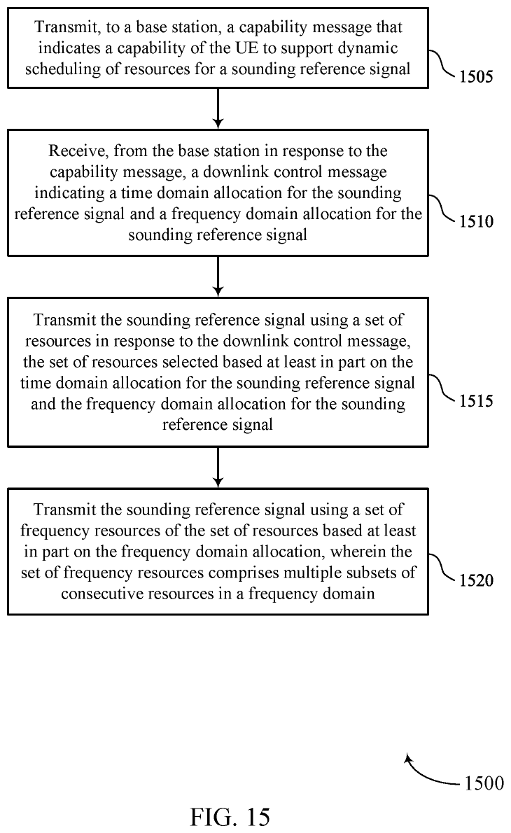

FIG. 15 shows a flowchart illustrating a method 1500 that supports enhancement for A-SRS scheduling in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include transmitting, to a base station, a capability message that indicates a capability of the UE to support dynamic scheduling of resources for a sounding reference signal. The operations of 1505 may be performed in accordance with examples as disclosed herein. In some examples, aspects of the operations of 1505 may be performed by a capability transmitter 725 as described with reference to FIG. 7.

At 1510, the method may include receiving, from the base station in response to the capability message, a downlink control message indicating a time domain allocation for the sounding reference signal and a frequency domain allocation for the sounding reference signal. The operations of 1510 may be performed in accordance with examples as disclosed herein. In some examples, aspects of the operations of 1510 may be performed by a control message receiver 730 as described with reference to FIG. 7.

At 1515, the method may include transmitting the sounding reference signal using a set of resources in response to the downlink control message, the set of resources selected based on the time domain allocation for the sounding reference signal and the frequency domain allocation for the sounding reference signal. The operations of 1515 may be performed in accordance with examples as disclosed herein. In some examples, aspects of the operations of 1515 may be performed by a reference signal transmitter 735 as described with reference to FIG. 7.

At 1520, the method may include transmitting the sounding reference signal using a set of frequency resources of the set of resources based on the frequency domain allocation, where the set of frequency resources includes multiple subsets of consecutive resources in a frequency domain. The operations of 1520 may be performed in accordance with examples as disclosed herein. In some examples, aspects of the operations of 1520 may be performed by a reference signal transmitter 735 as described with reference to FIG. 7.

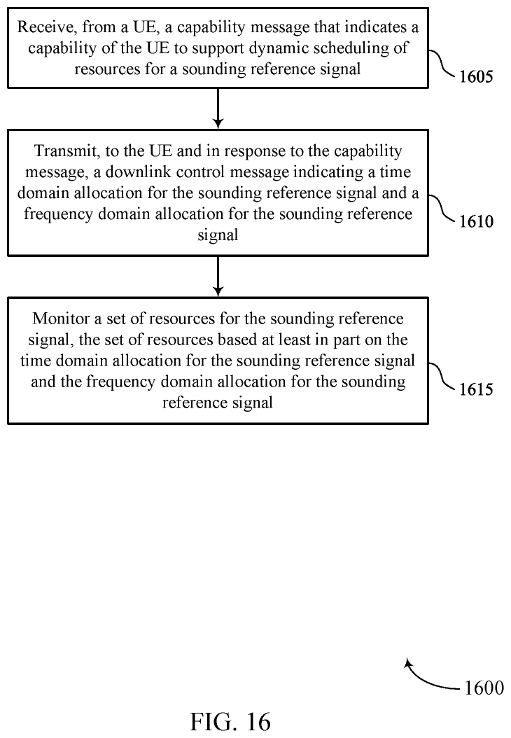

FIG. 16 shows a flowchart illustrating a method 1600 that supports enhancement for A-SRS scheduling in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include receiving, from a UE, a capability message that indicates a capability of the UE to support dynamic scheduling of resources for a sounding reference signal. The operations of 1605 may be performed in accordance with examples as disclosed herein. In some examples, aspects of the operations of 1605 may be performed by a capability receiver 1125 as described with reference to FIG. 11.

At 1610, the method may include transmitting, to the UE and in response to the capability message, a downlink control message indicating a time domain allocation for the sounding reference signal and a frequency domain allocation for the sounding reference signal. The operations of 1610 may be performed in accordance with examples as disclosed herein. In some examples, aspects of the operations of 1610 may be performed by a control message transmitter 1130 as described with reference to FIG. 11.

At 1615, the method may include monitoring a set of resources for the sounding reference signal, the set of resources based on the time domain allocation for the sounding reference signal and the frequency domain allocation for the sounding reference signal. The operations of 1615 may be performed in accordance with examples as disclosed herein. In some examples, aspects of the operations of 1615 may be performed by a resource monitoring manager 1135 as described with reference to FIG. 11.

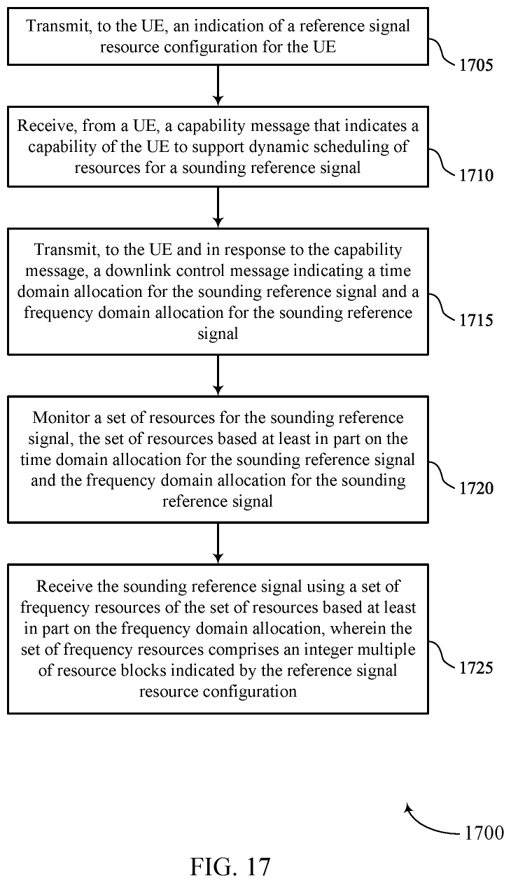

FIG. 17 shows a flowchart illustrating a method 1700 that supports enhancement for A-SRS scheduling in accordance with aspects of the present disclosure. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include transmitting, to the UE, an indication of a reference signal resource configuration for the UE. The operations of 1705 may be performed in accordance with examples as disclosed herein. In some examples, aspects of the operations of 1705 may be performed by a configuration indication transmitter 1145 as described with reference to FIG. 11.

At 1710, the method may include receiving, from a UE, a capability message that indicates a capability of the UE to support dynamic scheduling of resources for a sounding reference signal. The operations of 1710 may be performed in accordance with examples as disclosed herein. In some examples, aspects of the operations of 1710 may be performed by a capability receiver 1125 as described with reference to FIG. 11.

At 1715, the method may include transmitting, to the UE and in response to the capability message, a downlink control message indicating a time domain allocation for the sounding reference signal and a frequency domain allocation for the sounding reference signal. The operations of 1715 may be performed in accordance with examples as disclosed herein. In some examples, aspects of the operations of 1715 may be performed by a control message transmitter 1130 as described with reference to FIG. 11.

At 1720, the method may include monitoring a set of resources for the sounding reference signal, the set of resources based on the time domain allocation for the sounding reference signal and the frequency domain allocation for the sounding reference signal. The operations of 1720 may be performed in accordance with examples as disclosed herein. In some examples, aspects of the operations of 1720 may be performed by a resource monitoring manager 1135 as described with reference to FIG. 11.

At 1725, the method may include receiving the sounding reference signal using a set of frequency resources of the set of resources based on the frequency domain allocation, where the set of frequency resources includes an integer multiple of RBs indicated by the reference signal resource configuration. The operations of 1725 may be performed in accordance with examples as disclosed herein. In some examples, aspects of the operations of 1725 may be performed by a reference signal receiver 1140 as described with reference to FIG. 11.

The following provides an overview of aspects of the present disclosure:

Aspect 1: A method for wireless communications at a UE, comprising: receiving, from a base station, a downlink control message indicating a time domain allocation for a sounding reference signal and a frequency domain allocation for the sounding reference signal; and transmitting the sounding reference signal using a set of resources in response to the downlink control message, the set of resources selected based at least in part on the time domain allocation for the sounding reference signal and the frequency domain allocation for the sounding reference signal.

Aspect 2: The method of aspect 1, further comprising: transmitting, to the base station, a capability message that indicates a capability of the UE to support dynamic scheduling of resources for the sounding reference signal.

Aspect 3: The method of aspect 1, wherein transmitting the sounding reference signal comprises: transmitting the sounding reference signal using a set of frequency resources of the set of resources based at least in part on the frequency domain allocation, wherein the set of frequency resources is a truncated set of a total set of frequency resources indicated by the frequency domain allocation.

Aspect 4: The method of any of aspects 1 through 3, wherein transmitting the sounding reference signal comprises: transmitting the sounding reference signal using a set of frequency resources of the set of resources based at least in part on the frequency domain allocation, wherein the set of frequency resources comprises multiple subsets of consecutive resources in a frequency domain.

Aspect 5: The method of any of aspects 1 through 4, further comprising: receiving, from the base station, an indication of a reference signal resource configuration for the UE; and transmitting the sounding reference signal using a set of frequency resources of the set of resources based at least in part on the frequency domain allocation, wherein the set of frequency resources comprises an integer multiple of resource blocks indicated by the reference signal resource configuration.

Aspect 6: The method of any of aspects 1 through 5, wherein receiving the downlink control message comprises: receiving one or more bits indicating a bandwidth for the sounding reference signal, wherein the sounding reference signal is transmitted using the bandwidth.

Aspect 7: The method of any of aspects 1 through 6, wherein receiving the downlink control message comprises: receiving one or more bits indicating one or more resource configuration parameters for the sounding reference signal, wherein the sounding reference signal is transmitted in accordance with the one or more resource configuration parameters.

Aspect 8: The method of aspect 7, wherein the one or more resource configuration parameters comprises a bandwidth configuration index, a number of resource blocks, a number of sounding reference signals for transmission, a frequency hopping parameter, or any combination thereof.

Aspect 9: The method of any of aspects 1 through 8, wherein transmitting the sounding reference signal comprises: transmitting the sounding reference signal using a set of time resources of the set of resources based at least in part on the time domain allocation, wherein the time domain allocation indicates a starting symbol value for the sounding reference signal, a number of symbols for the sounding reference signal, a time offset for the sounding reference signal, a repetition factor, or any combination thereof.

Aspect 10: The method of any of aspects 1 through 9, further comprising: receiving a control message indicating a configuration for the UE for receiving the downlink control message.

Aspect 11: The method of aspect 10, wherein the configuration indicates a bitwidth for one or more fields of the downlink control message, the one or more fields indicate the set of resources for the sounding reference signal.

Aspect 12: The method of any of aspects 1 through 11, wherein transmitting the capability message comprises: transmitting an indication of a supported bandwidth for the sounding reference signal, a time offset for the sounding reference signal, or any combination thereof.

Aspect 13: The method of any of aspects 1 through 12, wherein receiving the downlink control message comprises: receiving, in the downlink control message, one or more bits indicating an absence of an uplink shared channel transmission via a physical uplink shared channel.

Aspect 14: The method of any of aspects 1 through 13, wherein receiving the downlink control message comprises: receiving, in the downlink control message, a frequency domain resource assignment field that indicates the frequency domain allocation.

Aspect 15: The method of any of aspects 1 through 14, wherein receiving the downlink control message comprises: receiving, in the downlink control message, a time domain resource assignment field that indicates the time domain allocation.

Aspect 16: A method for wireless communications at a base station, comprising: transmitting, to a UE, a downlink control message indicating a time domain allocation for a sounding reference signal and a frequency domain allocation for the sounding reference signal; and monitoring a set of resources for the sounding reference signal, the set of resources based at least in part on the time domain allocation for the sounding reference signal and the frequency domain allocation for the sounding reference signal.

Aspect 17: The method of aspect 16, further comprising: receiving, from the UE, a capability message that indicates a capability of the UE to support dynamic scheduling of resources for the sounding reference signal.

Aspect 18: The method of aspect 16, wherein monitoring the set of resources comprises: receiving the sounding reference signal over a set of frequency resources of the set of resources based at least in part on the frequency domain allocation, wherein the set of frequency resources is a truncated set of a total set of frequency resources indicated by the frequency domain allocation.

Aspect 19: The method of any of aspects 16 through 18, wherein monitoring the set of resources comprises: receiving the sounding reference signal using a set of frequency resources of the set of resources based at least in part on the frequency domain allocation, wherein the set of frequency resources comprises multiple subsets of consecutive resources in a frequency domain.

Aspect 20: The method of any of aspects 16 through 19, further comprising: transmitting, to the UE, an indication of a reference signal resource configuration for the UE; and receiving the sounding reference signal using a set of frequency resources of the set of resources based at least in part on the frequency domain allocation, wherein the set of frequency resources comprises an integer multiple of resource blocks indicated by the reference signal resource configuration.

Aspect 21: The method of any of aspects 16 through 20, wherein transmitting the downlink control message comprises: transmitting one or more bits indicating a bandwidth for the sounding reference signal, wherein monitoring for the sounding reference signal is based at least in part on the bandwidth.

Aspect 22: The method of any of aspects 16 through 21, wherein transmitting the downlink control message comprises: transmitting one or more bits indicating one or more resource configuration parameters for the sounding reference signal, wherein monitoring for the sounding reference signal is in accordance with the one or more resource configuration parameters.

Aspect 23: The method of aspect 22, wherein the one or more resource configuration parameters comprises a bandwidth configuration index, a number of resource blocks, a number of sounding reference signals for transmission, a frequency hopping parameter, or any combination thereof.

Aspect 24: The method of any of aspects 16 through 23, wherein monitoring the set of resources comprises: receiving the sounding reference signal using a set of time resources of the set of resources based at least in part on the time domain allocation, wherein the time domain allocation indicates a starting symbol value for the sounding reference signal, a number of symbols for the sounding reference signal, a time offset for the sounding reference signal, a repetition factor, or any combination thereof.

Aspect 25: The method of any of aspects 16 through 24, further comprising: transmitting a control message indicating a configuration for the UE for receiving the downlink control message.

Aspect 26: The method of aspect 25, wherein the configuration indicates a bitwidth for one or more fields of the downlink control message, the one or more fields indicate the set of resources for the sounding reference signal.

Aspect 27: The method of any of aspects 16 through 26, wherein receiving the capability message comprises: receiving an indication of a supported bandwidth for the sounding reference signal, a time offset for the sounding reference signal, or any combination thereof.

Aspect 28: The method of any of aspects 16 through 27, wherein transmitting the downlink control message comprises: transmitting, in the downlink control message, one or more bits indicating an absence of an uplink shared channel transmission via a physical uplink shared channel.

Aspect 29: The method of any of aspects 16 through 28, wherein transmitting the downlink control message comprises: transmitting, in the downlink control message, a frequency domain resource assignment field that indicates the frequency domain allocation.

Aspect 30: The method of any of aspects 16 through 29, wherein transmitting the downlink control message comprises: transmitting, in the downlink control message, a time domain resource assignment field that indicates the time domain allocation.

Aspect 31: An apparatus for wireless communications at a UE, comprising a processor; memory coupled with the processor; and instructions stored in the memory and executable by the processor to cause the apparatus to perform a method of any of aspects 1 through 15.

Aspect 32: An apparatus for wireless communications at a UE, comprising at least one means for performing a method of any of aspects 1 through 15.

Aspect 33: A non-transitory computer-readable medium storing code for wireless communications at a UE, the code comprising instructions executable by a processor to perform a method of any of aspects 1 through 15.

Aspect 34: An apparatus for wireless communications at a base station, comprising a processor; memory coupled with the processor; and instructions stored in the memory and executable by the processor to cause the apparatus to perform a method of any of aspects 16 through 30.

Aspect 35: An apparatus for wireless communications at a base station, comprising at least one means for performing a method of any of aspects 16 through 30.

Aspect 36: A non-transitory computer-readable medium storing code for wireless communications at a base station, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a memory and a processor coupled to the memory, the processor configured to:
receive, from a base station, a downlink control message indicating a time domain allocation for a sounding reference signal and a frequency domain allocation for the sounding reference signal; and
transmit the sounding reference signal using a set of resources in response to the downlink control message, the set of resources selected based at least in part on the time domain allocation for the sounding reference signal and the frequency domain allocation for the sounding reference signal.

2. The apparatus of claim 1, wherein the processor is configured to:
transmit, to the base station, a capability message that indicates a capability of the UE to support dynamic scheduling of resources for the sounding reference signal.

3. The apparatus of claim 1, wherein the processor is configured to:
transmit the sounding reference signal using a set of frequency resources of the set of resources based at least in part on the frequency domain allocation, wherein the set of frequency resources is a truncated set of a total set of frequency resources indicated by the frequency domain allocation.

4. The apparatus of claim 1, wherein the processor is configured to:
transmit the sounding reference signal using a set of frequency resources of the set of resources based at least in part on the frequency domain allocation, wherein the set of frequency resources comprises multiple subsets of consecutive resources in a frequency domain.

5. The apparatus of claim 1, wherein the processor is configured to:
receive, from the base station, an indication of a reference signal resource configuration for the UE; and
transmit the sounding reference signal using a set of frequency resources of the set of resources based at least in part on the frequency domain allocation, wherein the set of frequency resources comprises an integer multiple of resource blocks indicated by the reference signal resource configuration.

6. The apparatus of claim 1, wherein the processor is configured to:
receive one or more bits indicating a bandwidth for the sounding reference signal, wherein the sounding reference signal is transmitted using the bandwidth.

7. The apparatus of claim 1, wherein the processor is configured to:
receive one or more bits indicating one or more resource configuration parameters for the sounding reference signal, wherein the sounding reference signal is transmitted in accordance with the one or more resource configuration parameters.

8. The apparatus of claim 7, wherein the one or more resource configuration parameters comprises a bandwidth configuration index, a number of resource blocks, a number of sounding reference signals for transmission, a frequency hopping parameter, or any combination thereof.

9. The apparatus of claim 1, wherein the processor is configured to:
transmit the sounding reference signal using a set of time resources of the set of resources based at least in part on the time domain allocation, wherein the time domain allocation indicates a starting symbol value for the sounding reference signal, a number of symbols for the sounding reference signal, a time offset for the sounding reference signal, a repetition factor, or any combination thereof.

10. The apparatus of claim 1, wherein the processor is configured to:
receive a control message indicating a configuration for the UE for receiving the downlink control message.

11. The apparatus of claim 10, wherein:
the configuration indicates a bitwidth for one or more fields of the downlink control message,
the one or more fields indicate the set of resources for the sounding reference signal.

12. The apparatus of claim 1, wherein the processor is configured to:
transmit an indication of a supported bandwidth for the sounding reference signal, a time offset for the sounding reference signal, or any combination thereof.

13. The apparatus of claim 1, wherein the processor is configured to:
receive, in the downlink control message, one or more bits indicating an absence of an uplink shared channel transmission via a physical uplink shared channel.

14. The apparatus of claim 1, wherein the processor is configured to:
receive, in the downlink control message, a frequency domain resource assignment field that indicates the frequency domain allocation.

15. The apparatus of claim 1, wherein the processor is configured to:
receive, in the downlink control message, a time domain resource assignment field that indicates the time domain allocation.

16. An apparatus for wireless communications at a base station, comprising:
a memory and a processor coupled to the memory, the processor configured to:
transmit, to a user equipment (UE), a downlink control message indicating a time domain allocation for a sounding reference signal and a frequency domain allocation for the sounding reference signal; and
monitor a set of resources for the sounding reference signal, the set of resources based at least in part on the time domain allocation for the sounding reference signal and the frequency domain allocation for the sounding reference signal.

17. The apparatus of claim 16, wherein the processor is configured to:
receive, from the UE, a capability message that indicates a capability of the UE to support dynamic scheduling of resources for the sounding reference signal.

18. The apparatus of claim 16, wherein the processor is configured to:
receive the sounding reference signal over a set of frequency resources of the set of resources based at least in part on the frequency domain allocation, wherein the set of frequency resources is a truncated set of a total set of frequency resources indicated by the frequency domain allocation.

19. The apparatus of claim 16, wherein the processor is configured to:
receive the sounding reference signal using a set of frequency resources of the set of resources based at least in part on the frequency domain allocation, wherein the set of frequency resources comprises multiple subsets of consecutive resources in a frequency domain.

20. The apparatus of claim 16, wherein the processor is configured to:
transmit, to the UE, an indication of a reference signal resource configuration for the UE; and
receive the sounding reference signal using a set of frequency resources of the set of resources based at least in part on the frequency domain allocation, wherein the set of frequency resources comprises an integer multiple of resource blocks indicated by the reference signal resource configuration.

21. The apparatus of claim 16, wherein the processor is configured to:
transmit one or more bits indicating a bandwidth for the sounding reference signal, wherein monitoring for the sounding reference signal is based at least in part on the bandwidth.

22. The apparatus of claim 16, wherein the processor is configured to:
transmit one or more bits indicating one or more resource configuration parameters for the sounding reference signal, wherein monitoring for the sounding reference signal is in accordance with the one or more resource configuration parameters.

23. The apparatus of claim 16, wherein the processor is configured to:
receive the sounding reference signal using a set of time resources of the set of resources based at least in part on the time domain allocation, wherein the time domain allocation indicates a starting symbol value for the sounding reference signal, a number of symbols for the sounding reference signal, a time offset for the sounding reference signal, a repetition factor, or any combination thereof.

24. The apparatus of claim 16, wherein the processor is configured to:
transmit a control message indicating a configuration for the UE for receiving the downlink control message.

25. The apparatus of claim 16, wherein the processor is configured to:
receive an indication of a supported bandwidth for the sounding reference signal, a time offset for the sounding reference signal, or any combination thereof.

26. The apparatus of claim 16, wherein the processor is configured to:
transmit, in the downlink control message, one or more bits indicating an absence of an uplink shared channel transmission via a physical uplink shared channel.

27. The apparatus of claim 16, wherein the processor is configured to:
transmit, in the downlink control message, a frequency domain resource assignment field that indicates the frequency domain allocation.

28. The apparatus of claim 16, wherein the processor is configured to:
transmit, in the downlink control message, a time domain resource assignment field that indicates the time domain allocation.

29. A method for wireless communications at a user equipment (UE), comprising:
receiving, from a base station, a downlink control message indicating a time domain allocation for a sounding reference signal and a frequency domain allocation for the sounding reference signal; and
transmitting the sounding reference signal using a set of resources in response to the downlink control message, the set of resources selected based at least in part on the time domain allocation for the sounding reference signal and the frequency domain allocation for the sounding reference signal.

30. A method for wireless communications at a base station, comprising:
transmitting, to a user equipment (UE), a downlink control message indicating a time domain allocation for a sounding reference signal and a frequency domain allocation for the sounding reference signal; and
monitoring a set of resources for the sounding reference signal, the set of resources based at least in part on the time domain allocation for the sounding reference signal and the frequency domain allocation for the sounding reference signal.
